(19) United States
(12) Patent Application Publication
(10) Pub. No.: US 2011/0087602 A1
(43) Pub. Date: Apr. 14, 2011

(54) ELECTRONIC DISPLAY DEVICE CONTENT CACHING AND TRANSACTIONS

(76) Inventor: Serge RUTMAN, Boulder Creek, CA (US)

(21) Appl. No.: 12/578,987

(22) Filed: Oct. 14, 2009

(51) Int. Cl. G06Q 30/00; H04L 9/00; G06Q 10/00; G06Q 20/00; G06Q 50/00; H04M 11/00

(52) U.S. Cl. 705/52; 379/93.12; 705/27.1

(57) ABSTRACT

A system and method for purchases of stored electronic content stored on an electronic display device are disclosed. The system and method for purchases of stored electronic content may include identifying one or more portions of electronic content to provide on an electronic paper display device, providing the one or more portions of identified electronic content to storage of the electronic paper display device, wherein access to the one or more portions of identified electronic content is restricted, at least in part, until payment is received, providing content information associated with the stored electronic content to a user of the electronic paper display device, providing a payment method allowing the user of the electronic paper display device to purchase access to one or more portions of the stored electronic content while the electronic paper display device is disconnected from a network, and providing access to one or more purchased portions of the stored electronic content, wherein access includes access when the electronic paper display device is disconnected from a network.

### FIELD OF THE INVENTION

The present invention generally relates to a system for and method of using electronic display devices for storing of electronic content and allowing purchases of stored electronic content.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram of a system using electronic display devices for caching of electronic content and allowing purchases of cached content according to an embodiment of the present invention;

FIG. 2 shows a module for using electronic display devices for caching of electronic content and allowing purchases of cached content in accordance with an embodiment of the present disclosure;

FIG. 3A is a schematic diagram of an electronic display device according to an embodiment of the present invention;

FIG. 3B is a schematic diagram of an electronic display device according to an alternate embodiment of the present invention; and

FIG. 4 is a flow chart illustrating using electronic display devices for caching of electronic content and allowing purchases of cached content according to an embodiment of the present invention.

### DETAILED DESCRIPTION OF EMBODIMENTS

Certain embodiments of the present invention provide caching of electronic content and allowing purchases of cached content on an electronic display device. More particularly, certain embodiments of the present invention provide a system for and method of caching of electronic content and allowing purchases of cached content without the need for connection to any network. Such electronic content may be accessed, by way of non-limiting example, via a device utilizing an electronic paper display (referred to herein as “EPD”), such as electrophoretic displays or electro-wetting displays. Other embodiments may use an LCD (Liquid Crystal Display) based display, an LEP (Light Emitting Polymer) based display, a OLED (Organic Light Emitting Diode) based display, or other display technologies.

Caching of electronic content and allowing purchases of cached content may include not only uploading electronic content to a user device, but also identifying content to upload, producing, formatting, and aggregating electronic content. Caching of electronic content may include storing of electronic content on non-volatile memory associated with an electronic display device. Caching of electronic content may include providing electronic content on a recordable storage medium including, by way of non-limiting example, hard drives, DVDs (digital video disks), CDs (Compact Disks), optical disks, memory cards, magnetic tape, or other electronically readable storage. In one or more embodiments, a user device may be shipped or otherwise provided to a user with pre-loaded content. For example, an electronic paper display device may be sold or otherwise provided to a user with a variety or stored electronic content, such as, most popular electronic content, electronic content associated with demographics of a purchaser, or a sampling of electronic content from across a plurality of categories.

Caching or storing of electronic content on an electronic display device may allow subsequent purchases of one or more portions of the cached electronic content by a user of an electronic display device. Such purchases may be made offline (i.e., without access to network connectivity for an electronic display device). A user of an electronic display device may travel, commute, or otherwise be located somewhere without network access. During such periods (e.g., train rides, flights, travel abroad) a user of an electronic display device may be presented with information about electronic content cached on their electronic display device that is available for purchase. One or more purchase transactions may be permitted by an electronic display device without access to network connectivity.

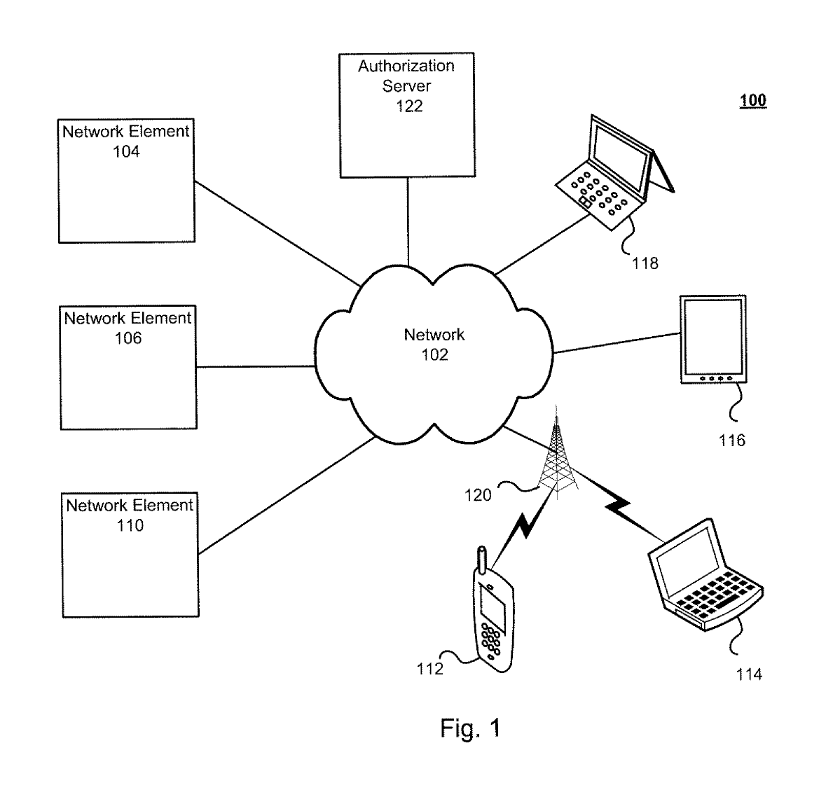

FIG. 1 is a schematic diagram of a system for managing access to electronic content according to an embodiment of the present invention. FIG. 1 is a simplified view of system 100, which may include additional elements that are not depicted. Network elements 104, 106, and 110 may be communicatively coupled to network 102. One or more of electronic display devices 112, 114, 116, and 118 may be communicatively coupled to network 102. In one or more embodiments, an electronic display device, such as electronic display device 116, may at times not be connected to a network. Authorization server 122 may also be communicatively coupled to network 102. As illustrated in FIG. 1, one or more electronic display devices may connect to network 102 via a wireless access point such as wireless access point 120.

Network 102 may be a local area network (LAN), a wide area network (WAN), the Internet, a cellular network, a satellite network, or another network that permits communication between network elements 104, 106, and 110, electronic display devices 112, 114, 116, and 118, and other devices communicatively coupled to network 102. In one or more embodiments, network 102 may be used to distribute electronic content. Exemplary content distribution networks are disclosed in U.S. application Ser. No. 12/248,482, titled “Systems, Methods and Apparatus for Content Distribution,” filed on Oct. 9, 2008 and U.S. provisional application No. 60/978,748, titled “Content Distribution and Preloading,” filed on Oct. 9, 2007; the contents of both applications are hereby incorporated by reference in their entireties.

Authorization server 122 may use Digital Rights Management (DRM), encryption, and conditional access technologies to validate and regulate access to electronic content. By way of non-limiting example, authorization server 122 may implement a conditional access system such as a system available from NDS Group, LTD. of Staines, United Kingdom. Authorization server 122 may communicate securely with a conditional access module and a decryption smart card or circuit associated with an electronic display device.

Network elements 104, 106, and 110 may be servers, network storage devices or other devices communicatively coupled to network 102. In one or more embodiments, network elements 104, 106, and 110 may perform any, or a combination, of storing, receiving, transmitting, producing, aggregating, and uploading electronic content. Network elements 104, 106, and 110 may also perform other electronic content management functionality including, but not limited to, any, or a combination, of account management, electronic payment processing and verification, target marketing of electronic content to electronic display device users, user electronic content tracking, and content distribution.

Network elements 104, 106, and 110 may contain or be communicatively coupled to storage, such as a redundant array of inexpensive disks (RAID), a storage area network (SAN), an internet small computer systems interface (iSCSI) SAN, a Fibre Channel SAN, a common Internet File System (CIFS), network attached storage (NAS), a network file system (NFS), tape drive based storage, or other computer accessible storage.

Network elements 104, 106, and 110 communicate with any, or a combination, of other systems, applications, and storage locations directly via one or more of an Application Programming Interface (API), a Remote Procedure Call (RPC), an interface table, a web service, an Extensible Markup Language (XML) based interface, a Simple Object Access Protocol (SOAP) based interface, a common request broker architecture (CORBA) based interface, and other interfaces for sending or receiving information. For example, network elements 104, 106, and 110 may communicate with accounting systems, marketing systems, interactive voice response (IVR) systems, systems of content providers, or other systems, servers, or components to facilitate electronic content caching and transactions.

Network elements 104, 106, and 110 may each be responsible for different functionality in an electronic content distribution network. By way of non-limiting example, network element 104 may produce, receive, organize and aggregate electronic content, such as periodicals, books, newsletters, or other electronic content. Such electronic content may be aggregated from one or more feeds, such as publishers, resellers, newspapers, journalists, news services, broadcasts, or other sources. Processing of electronic content may include any, or a combination, of indexing, categorizing, storing, formatting, translating, filtering, spell checking, compressing, encrypting, securing, replicating, and further processing. Electronic content may be produced by user or third-party input (e.g., blogs, newsletters, etc.). Such content may be input via, by way of non-limiting example, typed input or dictations processed by speech to text input (e.g., text of speeches, conferences, proceedings, hearings, etc.). Electronic content may be produced by scanning existing text, such as by way of non-limiting example, by Optical Character Recognition (OCR) processes. Other scanning processes may produce electronic content without performing OCR processes. Network element 104 may translate content from one format to another. For example, network element 104 may receive content from a subscriber and may translate the content into one or more electronic formats including, but not limited to, proprietary formats utilized by one or more e-book readers. Network element 104 may receive subscriber or user content via emails, FTP (File Transfer Protocol), HTTP (Hyper Text Transfer Protocol), text message (e.g., via Short Message Service (SMS)), Multi-Media Messaging Service (MMS), Wireless Access Protocol (WAP), or via other electronic communication protocols. Categorization of content by network element 104 may include any, or a combination, of organizing content, storing content, and indexing content by one or more of a subject, subscription, and access. By way of non-limiting example, content may be grouped or stored in databases or other storage which may be separated according to subscription.

According to one or more embodiments, network element 104 may identify electronic content for marketing to one or more users of electronic display devices. Network element 104 may receive account information indicating prior electronic content purchases, usages, viewings, searches, and requests of one or more users of electronic display devices. Account information may also include dates associated with one or more portions of electronic content on an electronic display device. For example, an age of electronic content, an expiration date associated with electronic content, and a last upload date associated with electronic content may be associated with account information. Network element 104 may receive and store demographic information associated with one or more users of electronic display devices, location information associated with one or more users of electronic display devices, preference information associated with one or more users of electronic display devices, sales information associated with one or more portions of electronic content, reviews of one or more portions of electronic content, ratings of one or more portions of electronic content, transaction statistics associated with electronic content, sales rankings of electronic content, and previews of one or more portions of electronic content. Preference information may include content areas of interest associated with a user including, but not limited to, authors, editors, publishers, publications, key words, topics, languages, hobbies, career, travel, educational, culture, preferred genres, and recreational interests. Network element 104 may analyze received information in order to identify one of more portions of content to upload to an electronic display device of a user. For example, network element 104 may analyze user preferences, user demographics, preferred language, and user transaction history. Network element 104 may analyze electronic content characteristics when identifying electronic content for marketing. For example, the size of electronic content, an estimated upload time for electronic content, a format of electronic content, and other characteristics associated with electronic content may be analyzed by network element 104.

In another example, marketing information may be received from a third party and the identification of electronic content may be associated with received marketing information. For example, network element 104 may receive information associated with recent purchases of a user associated with an electronic display device. The purchase information may be associated with or parsed for keywords or other indicators that may be associated with electronic content. As an example, if a recent purchase is associated with travel, electronic content associated with the destination such as guides, maps, local periodicals, language dictionaries, and other information, may be uploaded. If a recent purchase is associated with an item, uploaded electronic content may include user guides, manuals, or other information associated with the item. According to one or more embodiments, electronic content identification may be performed by a component of an end user device.

Network element 104 may determine when to identify one or more portions of electronic content for offering or marketing to a user based at least in part on least one of detecting network access of an electronic display device, user specified preferences, content provider preferences, and a periodic schedule. In one or more embodiments, electronic content may be identified by an electronic display device.

Network element 104 may organize or associate electronic content with demographic categories, user preferences, target market categories, or other marketing categories. According to one or more embodiments, network element 104 may place one or more portions of electronic content in a queue for uploading to an electronic display device. According to some embodiments, network element 104 may flag a portion of electronic content for upload to an electronic display device, insert or an entry into a log file, database or other electronic record, or otherwise indicate that one or more portions of electronic content have been identified for upload to an electronic display device of a user. According to at least one embodiment, Network element 104 may organize electronic content according to one or more categories and one or more electronic display devices may identify and download electronic content.

Network element 104 may generate marketing material associated with electronic content. Network element 104 may use received reviews of electronic content, ratings of electronic content, excerpts of electronic content, executive summaries of electronic content, or other materials associated with electronic content to generate marketing material for one or more portions of electronic content. For example, network element 104 may generate previews of electronic content. Network element 104 may generate notifications or offerings that may be associated with keywords, user requests, or electronic display device events. According to one or more embodiments, generation of previews or other marketing materials and activities may be performed by an electronic display device.

By way of non-limiting example, network element 106 may perform one or more account management functionalities. For example, network element 106 may contain or access one or more of user subscription information, accounting information, payment information, account identification, and statistics associated with user access to one or more portions of electronic content. Network element 106 may interface to other systems or components, either local or remote, such as accounting systems, Customer Relationship Management (CRM) systems, marketing systems, payment systems, authentication systems, network access servers, or other network systems or components. Network element 106 monitor one or more accounts and may monitor access to electronic content stored on, distributed by or accessible from network 102 or one or more devices communicatively coupled to network 102. Account information may be provided to network element 104 or other network accessible components to generate usage information, verify transactions, or for other functionality. Subscription information, usage agreement information, and registration information obtained from a user of an electronic content network may contain demographic information, preference information, or other information which may be utilized for marketing purposes.

Network element 106 may receive account information, payment information, transaction information, or other financial information from banks, credit card companies, electronic payment systems, interactive voice response systems, or other systems. Transaction and account information may be securely transmitted and stored using encryption and other security mechanisms. Network element 106 may verify payment, authorize transactions, record transactions, interface with accounting systems, or otherwise facilitate transactions. For example, network element 106 may receive account information and a transaction request from an electronic display device for processing. Account information may include credit card account information, debit card account information, bank account information, or other account information. The transaction request may be a request to purchase a specified amount of stored value credit to add to a stored value account. Other transaction requests may include a request to purchase a stored value token, such as a smart card, a prepaid card, or other stored value carrier. Transaction requests may also include processing of payments for offline (i.e., without access to network connectivity for an electronic display device) transactions, such as charging credit card accounts, debit accounts, bank accounts or other accounts for transactions completed while an electronic display device was offline.

According to one or more embodiments, users may require pre-approval for offline transactions. For example, account information or other information may be verified and stored in advance of an offline transaction. Credit checks or other authentication or verification steps may be taken. Network element 106 may transmit or provide a pre-approval indicator to one or more electronic display devices associated with a user or an account. The pre-approval indicator may be stored securely on an electronic display device associated with the user. Pre-approval may be for a specified transaction limit (e.g., a total sale amount, a maximum number of transactions in a specified time period, or other restrictions). According to some embodiments, pre-approval checking may not be required (e.g., an administrator or manager associated with a content provider may waive a pre-approval requirement, one or more users may be automatically pre-approved for a specified limit, and users may be automatically pre-approved based on a transaction history.) According to one or more embodiments, pre-approval may be performed as part of a user registration, account setup, or device registration process.

Third party account processors, partners, or other entities may perform one or more portions of account or transaction processing. Network element 106 may receive or transmit transaction information, account information, or other financial information with third party account processors, partners, or other entities.

In one or more embodiments, network element 106 may generate codes which may be associated with access to one or more portions of electronic content. Codes may be cryptographic keys, pins, passwords, digital certificates, or other security mechanisms which may be provided to an electronic display device to authenticate access to stored electronic content. These codes may be distributed in one or more channels and by one or more methods. For example, an electronic content distributor may utilize an Interactive Voice Response (IVR) system or a call center to facilitate telephone transactions for electronic content. A user of an electronic display device may be located in an area with no network connectivity but with cell phone connectivity. The user may use their cell phone to purchase a code from a call center, an IVR system, or another phone payment system associated with a content distributor. The user may provide credit card information, debit card information, bank account information or other payment information to the phone payment system. After payment verification, the system may provide a code to be entered into an electronic display device. In one or more embodiments, a user may communicate payment information via a cell phone text message sent to a payment system and may receive a code via a text message. The user may type the code into their electronic display device or provide it to their electronic display device through an interface. For example, the user may transmit the code via Bluetooth or another local interface to their electronic display device.

According to one or more embodiments, codes generated by network element 106 may be put on cards, such as prepaid cards, smart cards, magnetic stripe cards, cards embossed with a code, cards containing a bar code or other means. For example, a prepaid card may contain an embossed code which may be entered into an electronic display device. The code may be a cryptographic key, a pin, a password, or other security mechanism which may provide value to a stored value account on the electronic display device. Alternatively, the code may provide access to a specific portion of electronic content. For example, a code may unlock, decrypt or otherwise provide access to a specific periodical (e.g., a newspaper, a magazine, etc.). Other cards may contain a specified value that may be used to purchase one or more portions of stored or cached electronic content. For example, a smart card may contain a code (e.g., a cryptographic key, a digital certificate, a pin, etc), a Radio Frequency Identification (RFID) tag, one or more integrated circuits, a microprocessor, and other components. These components may be utilized to securely transmit a code to an electronic display device. For example, the code may be transmitted via RFID and a user may not be able to access the code directly. According to some embodiments, the card may act as a stored value card and may debit the value on the card after it is transferred to an electronic display device. Cards may be purchased in advance by a user of an electronic display device from an electronic content provider. Cards may be offered by vendors, third party resellers, distributors or other parties authorized by an electronic content provider. In one or more embodiments, a vendor may retain possession of a card or a code and may ensure that the code is entered and authenticated into a purchaser's device. This may reduce the likelihood of unauthorized distribution of a code. For example, a vendor may accept payment from a purchaser and may securely transfer stored value or a code from a vendor device to a user device using RFID, Bluetooth, or other interfaces. According to one or more embodiments, a vendor or other authorized party may sell storage media, such as by way of non-limiting example, flash memory storage cards, which may contain electronic content (e.g., guides for destinations of a flight, language dictionaries, maps, best sellers, current periodicals, etc.) and may be readable by a user of an electronic display device. Such content may be protected by digital rights management technologies, digital watermarks, encryption, or other protection.

The cards may contain text, icons, logos, trademarks, or other markings associated with a content provider, electronic content (e.g., the logo of a periodical), a third party vendor, a distributor, a partner, a reseller, an issuer, a purchaser (e.g., cards may be ordered in advance and mailed or otherwise distributed to a purchaser, cards may be provided by an employer to employees), a financial entity, an electronic display device manufacturer, or other entities or items. The cards may contain text or other indicators of a value amount, usage instructions, terms of use, an expiration date, a signature block, a hologram, and other information.

According to one or more embodiments, the code may contain a machine or account specific identifier. Electronic display devices may contain software or hardware which may permit only utilization of those keys which contain their machine or account specific identifier. This may prevent use of the code on a machine other than the electronic display device associated with the user. In one or more embodiments, electronic display device or account specific symmetric cryptography may be utilized (e.g., only a device with the proper key may be able to utilize a code). According to some embodiments, a code may be associated with electronic content it is used to access. A code may also contain time and date information and may expire after a specified period (e.g., a electronic display device may not accept a code, such as a digital certificate, that has expired).

An electronic display device may synchronize codes, stored value account information, cached electronic content access information, payment information, transaction information, and other information with network element 106 when network connectivity for an electronic display device is established. The presence of a code on a plurality of electronic display device other than an intended device (e.g., a device specified in the transaction purchasing the code, a device indicated by a unique device identifier present in the code, a device identified by a merchant selling the code, or a device associated with an account used to purchase the code) may result in one or more corrective actions. For example, electronic content associated with a code that was used on more than one electronic content device may be deleted or disabled. A registered account of a user associated with a code used on an electronic display device for which it is not authorized (e.g., a code used a second time on a different device) may be charged. According to one or more embodiments, one or more portions of an electronic display device containing an unauthorized code (e.g., copied or stolen) or unauthorized electronic content may be disabled. Exemplary systems and methods for disabling electronic display devices are disclosed in U.S. patent application Ser. No. ______ entitled “Disabling Electronic Display Devices” filed ______, which is hereby incorporated by reference in its entirety.

According to one or more embodiments, network element 110, or another component associated with an electronic content provider network, may upload one or more portions of electronic content to one or more electronic display devices. Network element 110 may upload electronic content in encrypted, or protected formats. Network element 110 may also upload metadata, marketing information, price information, or other information associated with uploaded electronic content. Uploaded electronic content may be selected from content identified, queued, or indicated by network element 104. Uploaded content may be compressed, or otherwise formatted prior to upload. Network element 110 may perform one or more checks prior to uploading. For example, network element 110 may ensure that an account, a subscription, an agreement, or other usage authorization associated with an electronic paper device is valid. Network element 110 may also compare an amount of storage available on an electronic display device for caching or storing content with an amount of storage required for one or more portions of electronic content identified for upload.

Network element 110 may also determine or identify an upload time. For example, network element 110 may upload marketing material and electronic content based upon off peak or low network utilization periods, a network connection time of the electronic display device, a periodic schedule, a preference specified by a user of the electronic display device, a preference specified by an electronic content provider, and an electronic content availability time (e.g., after the creation of a morning edition of a daily periodical). In one or more embodiments, network element 110 may receive network utilization data or other indicators of network traffic from other systems or network components, such as a network management system. Network element 110 may identify an upload time based upon the received network utilization data. According to some embodiments, network element 110 may upload electronic content to an electronic display device immediately upon connection of the electronic display device to a network if the electronic display device has been disconnected for a specified period of time (e.g., 6, 12, or 24 hours, or 1, 2, or 5 days, etc.). In one or more embodiments, electronic content may contain an expiration time or date. For example, electronic content may be news with an associated expiration date and the upload time may be scheduled prior to the expiration date of the electronic content.

In one or more embodiments, marketing information that is not associated with electronic content on an electronic display device may be uploaded by network element 110 to the electronic display device. A user may view such marketing information and may enter an order which may be processed online (e.g., content may be uploaded to an electronic display device in response to an order) or may be fulfilled later when an electronic display device is online (i.e., has network connectivity allowing the download of electronic content).

Electronic display devices 112, 114, 116, and 118 may be electronic book (e-book) readers, E-Ink® based devices, desktop computers, laptop computers, wireline phones, mobile phones, Personal Digital Assistants (PDA), personal media players, gaming devices, or other devices capable of displaying electronic content. In one or more embodiments, electronic display devices 112, 114, 116, and 118 may access electronic content locally via one or more device interfaces.

According to some embodiments, electronic display devices 112, 114, 116, and 118 may access electronic content via one or more network interfaces. Electronic display devices 112, 114, 116, and 118 may transmit and receive data to and from network 102 utilizing a standard telecommunications protocol or a standard networking protocol. By way of non-limiting example, one embodiment may utilize FTP (File Transfer Protocol), HTTP (Hyper Text Transfer Protocol), Wireless Application Protocol (WAP), Multimedia Messaging Service (MMS), Enhanced Messaging Service (EMS), Short Message Service (SMS), Global System for Mobile Communications (GSM) based systems, Transmission Control Protocol/Internet (TCP/IP) Protocols, or other protocols or systems suitable for transmitting and receiving electronic content data. Electronic content may be transmitted and received wirelessly or may utilize cabled network or telecom connections such as an Ethernet RJ45/Category 5 connection, a fiber connection, a traditional phone wireline connection, a cable connection or other wired network connection. Electronic display devices 112, 114, 116, and 118 may use standard wireless protocols including WEE 802.11 and 802.16. Electronic display devices 112, 114, 116, and 118 may also be connected to network 102 via protocols for a wired connection, such as an IEEE Ethernet 802.3.

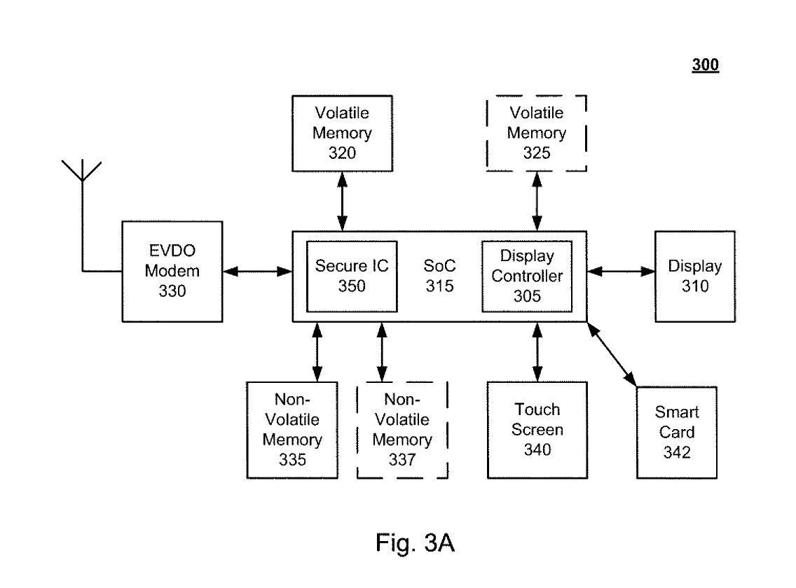

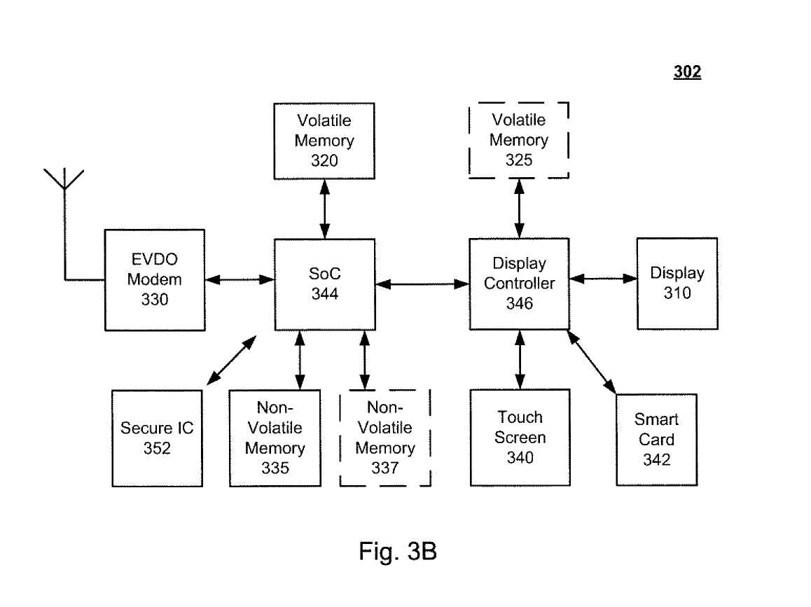

By way of non-limiting example, electronic display devices 112, 114, 116, and 118 may contain one or more interfaces including, a USB (Universal Serial Bus) connection, a RS-232 or serial connection, a Bluetooth connection, a RFID (Radio Frequency IDentification) reader or interrogator, a RFID tag (active or passive), a firewire connection, or interfaces supporting storage media (e.g., flash memory cards, CDs, DVDs). Electronic content may be received by an end user on electronic storage media and may be loaded onto or accessed by an electronic display device via one or more interfaces. As described in more detail with reference to FIGS. 3A and 3B below, an electronic display device may contain non-volatile memory for storing cached electronic content.

Electronic display devices 112, 114, 116, and 118 may receive a code, stored value, electronic content, electronic content marketing information, or other information through one or more interfaces. For example, a code entered via a keypad of the electronic display device, via a touch screen of the electronic display device, by scanning a RFID tag associated with a card, by inserting a dongle into the electronic display device (e.g., inserting into a USB port), receiving a Bluetooth signal from a cell phone, and inserting a memory card containing the code (e.g., a removable flash memory card).

In one or more embodiments, electronic display devices 112, 114, 116, and 118 may connect to a content provider network, such as network 102, and may download one or more portions of identified electronic content. Electronic display devices 112, 114, 116, and 118 may download electronic content identified by network element 104 or another network component. Electronic display devices 112, 114, 116, and 118 may additionally or alternatively identify electronic content to download. Electronic display devices 112, 114, 116, and 118 may utilize locally stored preferences and an algorithm to identify electronic content to download. Electronic display devices 112, 114, 116, and 118 may identify content to download based at least in part on attributes of categories of content identified by network element 104.

One or more electronic display device events may trigger marketing, offering, or previewing of stored electronic content. Electronic display device events may include detection of a user completion of stored electronic content, device instantiation, device idle time within a specified range (e.g., 30 minutes, 1 hour, 5, hours, 1 day, or other time based increments), user access of electronic content, a user search for electronic content, a user instantiation of an application, or other events. For example, an electronic device may be able to determine page accesses of electronic content and the closing of an electronic content file. Upon closing of an electronic content file for which the last page or a substantial portion of pages have been accessed, an electronic device may display information, a notification, or a preview associated with stored or cached electronic content available for purchase. In another example, the first time an electronic display device is instantiated on a particular day an electronic display device may display a notification or preview of a daily periodical available for purchase. Other factors may determine whether electronic content is offered such as, for example, whether the electronic content has previously been offered, whether an electronic display device is currently connected to a network, and the preferences of a user. In one or more embodiments, notifications or previews of electronic content may allow a user to provide feedback associated with their interests that may be used for future electronic content identification. Notifications or previews may allow a user to search for and review other stored electronic content previews or notifications. Users may be able to opt out of previews or specify preferred preview or marketing settings, according to some embodiments.

According to one or more embodiments, electronic display devices 112, 114, 116, and 118 may contain a Global Positioning System (GPS) receiver or other components capable of approximating the location of an electronic display device. Other methods of approximating location may be used including, but not limited to, cellular telecommunications handoff algorithms, network triangulation, trilateration, multilateration, measurements of signal strength, measurements of signal attenuation, measurements of noise, and dynamically associated network address information (e.g., detecting that a user device is associated with a network address of a service provider in a particular region). In one or more embodiments, electronic display devices 112, 114, 116, and 118 may contain mapping software allowing a user to specify a current location and obtain directions and other information. Location information obtained from these techniques and others may be used in order to offer a user of an electronic display device with location specific content (e.g., maps, guides, news, weather, etc.).

Electronic display devices 112, 114, 116, and 118 may be capable of processing payment without network connectivity. For example, electronic display devices 112, 114, 116, and 118 may receive account information, such as credit account information, debit account information, checking account information, or other bank account information. Electronic display devices 112, 114, 116, and 118 may perform one or more verification checks on the provided account information (e.g., a checksum, a verification code) and may record a transaction. The recorded transaction information may be associated with access to stored electronic content. Transaction information may be transmitted or synchronized when an electronic display device reconnects to a network.

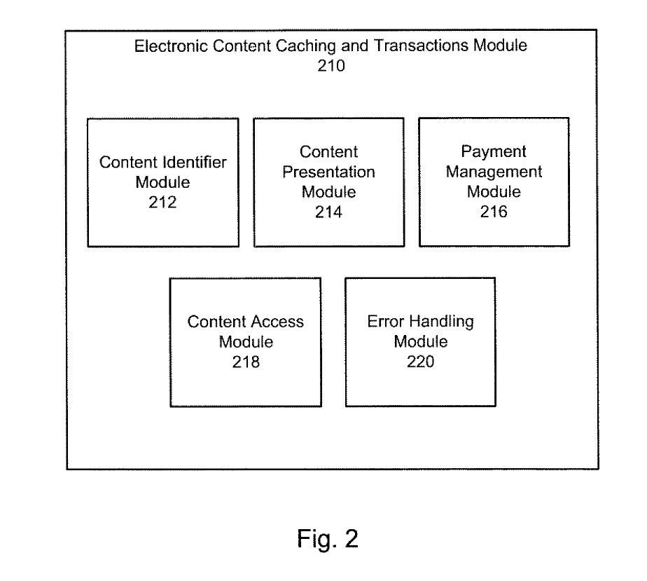

FIG. 2 shows electronic content caching and transactions module 210 for using electronic display devices for caching of electronic content and allowing purchases of cached content in accordance with an embodiment of the present disclosure. Electronic content caching and transactions module 210 may contain one or more components including content identifier module 212, content presentation module 214, payment management module 216, content access module 218, and error handling module 220. One or more portions of electronic content caching and transactions module 210 may be located on a user device, such as an electronic display device. According to some embodiments, one or more portions of electronic content caching and transactions module 210 may be located on a network.

Content identifier module 212 may identify one or more portions of electronic content for upload to a user device as content most likely to be desired by a user (e.g., by storing in memory data indicating a portion of electronic content). The content identification may be based at least in part on at least one of prior selections of a user associated with the electronic display device, electronic content previously examined by a user associated with the electronic display device, a location of a user associated with the electronic display device, a destination of a user associated with the electronic display device, best selling electronic content, prior subscriptions of a user associated with the electronic display device, demographics of a user associated with the electronic display device, user preferences of a user associated with the electronic display device, electronic content on sale, or other factors. Locations or destinations of an electronic paper display device may be specified by a user. In one or more embodiments, locations may generally determined by a network address associated with a last connection. Demographics of a user may be obtained from third party marketing databases, from user surveys, information gathered during user registration, and from other sources. An electronic display device may track or receive statistics associated with user purchases, user searches, user downloads, and other statistics. An electronic display device may track user access statistics associated with electronic content such as time spent on electronic content, pages accessed of electronic content, etc.

According to one or more embodiments, content identifier module 212 may determine when to identify one or more portions of content to provide to an electronic display device based on one or more factors. The factors may include one or more of detecting a percentage of used cached content, detecting a last download date of cached content, detecting an expiration date of cached content, detecting network access of an electronic display device, user specified preferences, content provider preferences, a user request for suggested content, and a periodic schedule. For example, a content identifier module 212 may determine that a certain portion of cached content has been read and may schedule a download of electronic content. In another example, content identifier module 212 may periodically download electronic content. Electronic content and associated marketing materials which have not been accessed and purchased may age out or expire (i.e., if electronic content is older than a specified age and no review of marketing material or purchases have occurred, the electronic content and associated marketing material may be deleted.) Content identifier module 212 may delete or replace expired or aged out electronic content. If a user has provided negative feedback to a notification or preview, associated electronic content may be deleted immediately, at the time of the next download of electronic cached content, or within a specified time period. Content identifier module 212 may determine the amount of electronic content to cache based upon available storage space of an electronic display device, an estimated download time, user preferences, and other factors.

According to one or more embodiments, content identifier module 212 may schedule downloading based at least in part on at least one of a low network utilization period, a network connection time of the electronic display device, a periodic schedule, a preference specified by a user of the electronic display device, a preference specified by an electronic content provider, and an electronic content availability time. For example, content identifier module 212 may schedule early morning downloading in order to download electronic content at a low network utilization time period and in order to download a morning edition of a daily periodical. The scheduling of content downloading may depend on other factors including, but not limited to, the last time electronic content was provided to a particular electronic display device, an expiration date of electronic content, a size of electronic content (e.g., larger sized electronic content may be queued for later delivery and smaller sized electronic content may be delivered sooner), and a marketing opportunity (e.g., a sale of electronic content, a recent transaction of a user of an electronic display device).

Content presentation module 214 may generate notifications, previews, or other marketing information associated with electronic content. Content presentation module 214 may provide a preview of the stored electronic content including at least one of: providing access to one or more portions of the stored electronic content, providing access to reviews of the stored electronic content, and providing access to a first chapter of the stored electronic content. Content presentation module 214 may generate by a preview by decrypting or otherwise accessing one or more selected portions of cached electronic content. Previews or notifications may be presented to a user via a user interface of an electronic display device. Previews or notifications may allow users to proceed to purchase electronic content. Previews or notifications may allow users to rate or offer feedback on electronic content.

Payment management module 216 may allow a user to pay for electronic content. In one or more embodiments, payment management module 216 may facilitate offline payment methods. Payment management module 216 may create and manage a stored value account. Payment management module 216 may perform purchase transactions by debiting a stored value account. In one or more embodiments, payment management module 216 may utilize external stored value accounts, such as stored value cards. Payment management module 216 may authenticate stored value cards and facilitate a transaction utilizing a stored value card. Authentication of a stored value card may utilize a magnetic stripe of a stored value card, a RFID tag of a stored value card, a code associated with a stored value card or other mechanisms. For example, an electronic display device may be associated with or may contain a RFID reader or interrogator. Payment management module 216 may utilize a RFID reader to authenticate and access a stored value card or for other RFID based communications.

Payment management module 216 may also allow a user of an electronic display device to provide payment information such as credit card account information, debit card account information, bank account information, or other information. Payment management module 216 may facilitate storage of payment information. Payment management module 216 may perform one or more offline payment verification processes. For example, payment management module 216 may perform credit card check digit validation to ensure that a credit card number represents a valid combination. Other verification may utilize a card security code, an expiration date, and other data. Payment management module 216 may facilitate transaction recording and may securely transmit payment information for processing when network connectivity for the electronic display device is established.

In one or more embodiments, payment management module 216 may recognize codes or indicators of payment. For example, a user may purchase a code and the code may be transmitted or provided to payment management module 216 for verification or validation. A code may be a pin, a password, a digital certificate, or other indicia of payment. A user may enter a code into the electronic display device and payment management module 216 may validate the code. In one or more embodiments, a user may purchase a code via a telephone payment system (e.g., a user may at the time have cell phone connectivity but not network access) and the user may provide the code to an electronic display device. In some embodiments, a user may purchase a code from a vendor.

Content access module 218 may provide access to one or more purchased portions of electronic content. According to some embodiments, content access module 218 may decrypt purchased electronic content. Content access module 218 may providing access to a previously restricted portion of non-volatile memory, providing access to a previously restricted hardware interface, implementing a software driver, installing a software component, or powering a hardware component.

Error handling module 220 may handle errors associated with electronic content caching, selection, presentation, payment, and access. Error handling module 220 may log errors, send notifications, or perform corrective actions. For example, error handling module 220 may retry content access (e.g., decryption), retry electronic content preview generation, and retry payment acceptance (e.g., access to a stored value account).

FIG. 3A is a schematic diagram of an electronic display device according to an embodiment of the present invention. An exemplary such display may be an EPD such as disclosed in U.S. patent application Ser. No. 12/497,199 entitled “Electronic Display Controller,” filed Jul. 2, 2009, which is hereby incorporated by reference in its entirety. Other embodiments may use a LCD (Liquid Crystal Display) based display, a LEP (Light Emitting Polymer) based display, an OLED (Organic Light Emitting Diode) based display, or other display technologies. Display controller 305 may be an integrated component of Soc 315. Display controller 305 may be utilized to disable the display of electronic content. Display controller 305 may access display 310 via SoC 315. Display 310 displays content in accordance with the system of electronic book 300. Display controller 305 may also be coupled to touch screen component 340 via SoC 315, which may be coextensive with display 310. That is, display 310 may include touch screen capabilities by way of incorporation of touch screen 340. Display controller 305 may further be coupled to external memory 320 and 325 via SoC 315. External memory 320 may be, by way of non-limiting example, a SDRAM integrated circuit. Display controller 305 may be further coupled, via SoC 315, to a sub-system that allows electronic book 300 to send and receive data, such as book, magazine and newspaper content. According to some embodiments, secure IC 350 may be a component of or integrated with SoC 315. Secure IC 350 may receive encryption keys, unscramble data, and perform other security related measures. Secure IC 350 may communicate with an authentication server or an authorization server such as authorization server 122 of FIG. 1. Having a display controller contain embedded security functionality may reduce vulnerability by reducing a chance that a security mechanism may be bypassed. Embedded security functionality may prevent exposure of vulnerable communication paths between security circuitry and display circuitry by reducing the communication path to one or more circuit traces. The subsystem includes evolution data optimized (“EVDO”) modem 330, which itself may be coupled to antenna 345 and to a system-on-chip (“SoC”) application specific integrated circuit (“ASIC”) 315. SoC 315 acts as an intermediary between EVDO modem 330 and display controller 305. SoC 315 may be further coupled to external volatile memory 320 (e.g., a SDRAM integrated circuit), to external persistent memory 335 (e.g., a flash memory integrated circuit), and optional external persistent memory 337 (e.g., removable storage media, a flash memory card). An external temperature sensor (not shown) may be coupled to display controller 305 via SoC 315.

SoC 315 may manage access to external persistent memory 335 and optional external persistent memory 337. SoC 315 may restrict access to one or more portions of memory based upon one or more factors including payment for electronic content stored in portions of memory. For example, SoC 315 may restrict access to a portion of optional external persistent memory 337 storing electronic content. SoC 315 may restrict browse access, read access, or other access to portions of a file system storing electronic content. SoC 315 may control other mechanisms for restricting access including decryption mechanisms which may be required to access electronic content. SoC 315 may utilize other mechanisms to control access such as, by way of non-limiting example, controlling access to a previously restricted hardware interface (e.g., a controller), implementing a software driver, installing a software component, and powering a hardware component.

In one or more embodiments, SoC 315 may contain or interface with a payment management module, such as a stored value management module. For example, SoC 315 may be coupled to smart card 342 via one or more interfaces (e.g., a RFID based interface and a reader/contact based interface.) SoC 315 may verify payment for stored electronic content prior to providing access. SoC 315 may flag or otherwise indicate one or more portions of storage once payment has been initially verified so that subsequent access may not require payment verification. SoC 315 may subsequently restrict access to one or more portions of electronic content if a problem with a payment occurs (e.g., an offline payment fails during later processing). For example, SoC 315 may receive credit card account information from a user during a flight. SoC 315 may perform one or more checks to verify the credit card account information without connecting to a network. For example, SoC 315 may compute a checksum, use a verification code, check an account number length, verify that a card has not expired (e.g., check an expiration date), or perform other checks. SoC 315 may utilize storage, including, but not limited to, non-volatile memory 335 to store account information. Upon subsequent connection to a network, SoC 315 may transmit payment information and receive verification. If verification or authorization fails SoC 315 may restrict access to one or more portions of electronic content associated with the payment.

FIG. 3B is a schematic diagram of an electronic display device according to an alternate embodiment of the present invention. As illustrated in FIG. 3B, electronic book 310 may contain many of the same components of electronic book 300. Electronic book 310 may however contain SoC 344 and display controller 346. SoC 344 may perform substantially the same functionality as SoC 315, but may not contain an integrated display controller. SoC 344 may interface or couple with display controller 346. Display controller 346 may perform substantially the same functionality as display controller 305, but may not be an integrated component of Soc 344. Display controller 346 may interface directly with one or more components, such as, volatile memory 325. touch screen 340, display 310, and smart card 342. Soc 344 may also integrate with Secure IC 352. Secure IC 352 may perform substantially the same functionality as secure IC 350, but may not be an integrated component of SoC 344.

According to some embodiments, display controller 346 may limit or control access to electronic content. Display controller 346 may contain or interface with a payment management module, such as a stored value management module. For example, display controller 346 may verify an amount of stored value on smart card 342 prior to allowing access to stored electronic content.

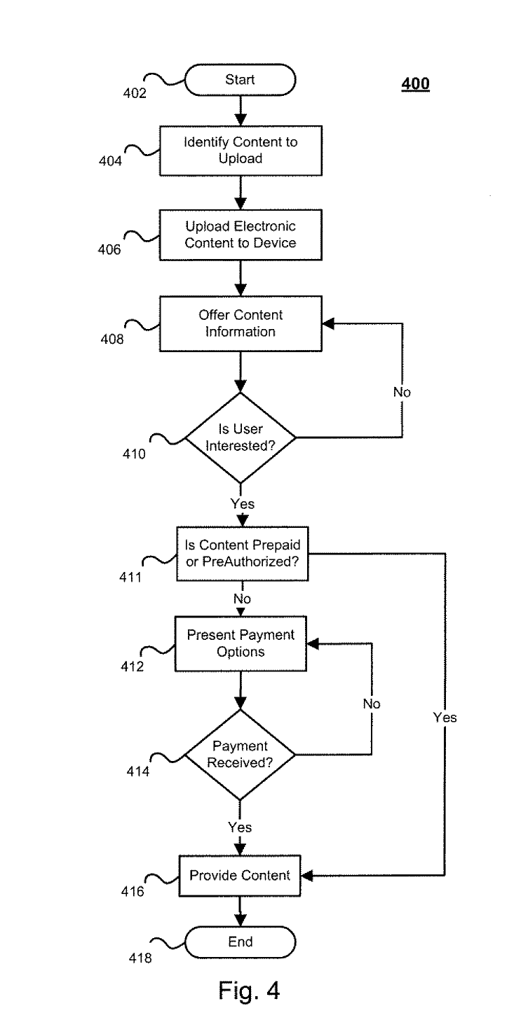

FIG. 4 is a flow chart illustrating method 400 for caching of electronic content and allowing purchases of cached content according to an embodiment of the present invention. At block 402, the method 400 for caching of electronic content and allowing purchases of cached content, in accordance with an exemplary embodiment, may begin.

At block 404, the method 400 may identify content to upload. As described above with reference to FIG. 2, a content identifier module 212 or other components may utilize demographics, user preferences, transaction histories, and other factors to identify one or more portions of content to upload.

At block 406, electronic content may be uploaded (or downloaded) to an electronic display device. Either a component associated with a content provider network, a component of an electronic display device, or both may initiate a transfer of electronic content. Electronic content may be transferred at specified times, such as off-peak network times, user specified times, and content provider specified times. Electronic content may be transferred using one or more secure mechanisms such as encryption.

At block 408, electronic content information may be offered to a user of an electronic display device. Electronic content information may be offered as a preview showing one or more portions of the content (e.g., cover, table of contents, first chapter, index), reviews, ratings, sales statistics, quotations, and other marketing information associated with the content. Electronic content information may be provided as a notification to a user. Previews and notifications may request and gather user feedback on electronic content offerings.

At block 410, a determination may be made as to whether a user is interested in an electronic content offering. A user may select an offering, click on an offering, tap an offering, or provide other input via a user interface indicating interest in an electronic content offering. If a user is interested the method may continue at block 411. If a user is not interested the method may return to block 408 to offer other content information. In one or more embodiments, if a user is not interested the method may end.

At block 411, a determination may be made as to whether content selected by a user is prepaid or access to such content is preauthorized. If content is prepaid or access is preauthorized, the method may continue at block 416. If content is not prepaid and access is not preauthorized, the method may continue at block 412.

At block 412, a user may be presented with payment options. Payment options may display on a user interface transaction information such as items selected for purchase, cost, etc. A user interface may allow a user to enter payment information such as credit account information, debit account information, bank account information, or other information. In one or more embodiments, a stored value account may be used or a user may be pre-approved for a transaction.

At block 414, after receiving payment information, payment verification steps may be taken. In one or more embodiments, only offline payment verification may be possible. For example, a checksum or card security code may be validated. An account number, an expiration date, or other account information may be verified for completeness, length, or other details. In embodiments, where a transaction is processed offline, payment information may later be transmitted to a merchant, a bank, a processor, an issuer, a electronic content provider, or other authorized parties. In one or more embodiments, payment verification may comprise utilizing a stored value account associated with an electronic display device or an external stored value card, such as a RFID enabled card containing a stored value amount.

According to some embodiments, minimal payment information may be required prior to a user being presented with content at block 416. In these embodiments, one or more payment verification or processing steps may occur after block 418. For example, a user may be presented simply with a cost and a verification that they want to purchase the material. A user may have previously stored account information may a default payment method. A user may also choose an option such as “bill me” and may be billed for the purchase later. The ability of a user to provide payment information or verification later may depend on one or more factors such as an electronic content provider's willingness to extend credit, a prior contract, the credit rating of a user, the credit rating of an organization associated with a user, the amount of the purchase, or other factors.

If payment has been received the method may continue at block 416. If a user cancels a transaction or payment has not been received, the method may return to block 412.

At block 416, electronic content may be provided to a user of an electronic display device. The electronic content may have been previously stored or cached on the electronic display device in an encrypted or otherwise secured format. Upon payment verification one or more portions of the electronic content may be decrypted. In one or more embodiments, one or more digital rights management technologies may be utilized to manage access to electronic content. Other method of managing access to electronic content may include removing one or more software components of the end user device. For example, software components may be removed including one or more operating system components, authentication software, digital certificates, credentials, and display control software.

At block 418, the method 400 may end.

Other embodiments, uses, and advantages of the present invention will be apparent to those skilled in the art from consideration of the specification and practice of the present invention disclosed herein. The specification and drawings should be considered exemplary only, and the scope of the present invention is accordingly intended to be limited only by the following claims and equivalents thereof.

We claim:

1. A hardware implemented method for purchases of electronic content stored on an electronic paper display device, the method comprising:
identifying one or more portions of electronic content to provide on an electronic paper display device;
providing the one or more portions of identified electronic content to storage of the electronic paper display device, wherein access to the one or more portions of identified electronic content is restricted, at least in part, until payment is received;
providing content information associated with the stored electronic content to a user of the electronic paper display device;
providing a payment method allowing the user of the electronic paper display device to purchase access to one or more portions of the stored electronic content while the electronic paper display device is disconnected from a network; and
providing access to one or more purchased portions of the stored electronic content, wherein access includes access when the electronic paper display device is disconnected from a network.

2. The method of claim 1, wherein the payment method comprises debiting a stored value account.

3. The method of claim 1, wherein the stored value account is stored on the electronic paper display device.

4. The method of claim 1, wherein the stored value account is stored on a stored value card.

5. The method of claim 4, further comprising authenticating the stored value card utilizing one or more components of the electronic paper display device.

6. The method of claim 1, wherein the payment method comprises accepting payment information to be transmitted when network connectivity for the electronic paper display device is established.

7. The method of claim 1, wherein the offline payment method comprises:
receiving, in the electronic paper display device, a code purchased for access to a portion of cached electronic content; and
validating the code in the electronic paper display device.

8. The method of claim 7, further comprising:
accepting payment via a telephone payment system for the code; and
providing the code via the telephone payment system.

9. The method of claim 7, further comprising:
providing a prepaid card containing the code.

10. The method of claim 7, wherein the code comprises a code for access to a specified unit of stored electronic content including at least one of: a book, a periodical, a manual, and a publication.

11. The method of claim 7, wherein the code comprises a code for access to specific stored electronic content.

12. The method of claim 7, wherein the code comprises a code providing a specified amount of value, and wherein validating the code in the electronic paper display device comprises comparing the amount of the specified value against a specified cost of a portion of stored electronic content selected for purchase by a user of the electronic paper display device.

13. The method of claim 7, wherein receiving the code in the electronic paper display device comprises at least one of: receiving the code via a keypad of the electronic paper display device, receiving the code via a touchscreen of the electronic paper display device, receiving the code via a scanned RFID tag associated with a card, receiving the code via an inserted dangle into the electronic paper display device, receiving a bluetooth signal from a cell phone, and reading an inserted memory card containing the code.

14. The method of claim 1, wherein providing access to one or more purchased portions of the stored electronic content comprises decrypting the one or more purchased portions of the stored electronic content.

15. The method of claim 1, wherein providing access to one or more purchased portions of the stored electronic content comprises at least one of: providing access to a previously restricted portion of non-volatile memory, providing access to a previously restricted hardware interface, implementing a software driver, installing a software component, and powering a hardware component.

16. The method of claim 1, wherein identifying one or more portions of electronic content comprises identifying electronic content based at least in part on at least one of:
prior selections of a user associated with the electronic paper display device, electronic content previously examined by a user associated with the electronic paper display device, a location of a user associated with the electronic paper display device, a destination of a user associated with the electronic paper display device, best selling electronic content, prior subscriptions of a user associated with the electronic paper display device, demographics of a user associated with the electronic paper display device, user preferences of a user associated with the electronic paper display device, and electronic content on sale.

17. The method of claim 1, further comprising:
determining when to identify one or more portions of content based at least in part on least one of: detecting a percentage of used cached content, detecting a last upload date of cached content, detecting an expiration date of cached content, detecting network access of an electronic paper display device, user specified preferences, content provider preferences, and a periodic schedule.

18. The method of claim 1, wherein providing content information associated with the stored electronic content comprises providing a preview of the stored electronic content.

19. The method of claim 18, providing a preview of the stored electronic content comprises at least one of: providing access to one or more portions of the stored electronic content, providing access to reviews of the stored electronic content, and providing access to a first chapter of the stored electronic content.

20. The method of claim 1, wherein providing the one or more portions of identified electronic content comprises downloading which is scheduled based at least in part on at least one of: a low network utilization period, a network connection time of the electronic paper display device, a periodic schedule, a preference specified by a user of the electronic paper display device, a preference specified by an electronic content provider, and an electronic content availability time.

21. At least one processor readable storage medium for storing a computer program of instructions configured to be readable by at least one processor for instructing the at least one processor to execute a computer process for performing the method as recited in claim 1.

22. A system for purchases of cached electronic content stored on an electronic paper display device comprising:
one or more processors, wherein the one or more processors are configured to:
identify one or more portions of electronic content to provide on an electronic paper display device;
provide the one or more portions of identified electronic content to storage of the electronic paper display device, wherein access to the one or more portions of identified electronic content is restricted, at least in part, until payment is received;
provide content information associated with the stored electronic content to a user of the electronic paper display device;
provide a payment method allowing the user of the electronic paper display device to purchase access to one or more portions of the stored electronic content while the electronic paper display device is disconnected from a network; and
provide access to one or more purchased portions of the stored electronic content, wherein access includes access when the electronic paper display device is disconnected from a network.

23. An electronic paper display device comprising:
a persistent display for displaying electronic content;
a communications module for receiving electronic content; and
a processor communicatively coupled to the display and the communications module, wherein the processor is configured to:
identify one or more portions of electronic content to provide on an electronic paper display device;
provide the one or more portions of identified electronic content to storage of the electronic paper display device, wherein access to the one or more portions of identified electronic content is restricted, at least in part, until payment is received;
provide content information associated with the stored electronic content to a user of the electronic paper display device;
provide a payment method allowing the user of the electronic paper display device to purchase access to one or more portions of the stored electronic content while the electronic paper display device is disconnected from a network; and
provide access to one or more purchased portions of the stored electronic content, wherein access includes access when the electronic paper display device is disconnected from a network.
